(19) United States
(12) Patent Application Publication
(10) Pub. No.: US 2021/0090409 A1
(43) Pub. Date: Mar. 25, 2021

(54) PAYMENT APPARATUS AND PAYMENT METHOD FOR A PAYMENT APPARATUS

(71) Applicant: TOSHIBA TEC KABUSHIKI KAISHA, Tokyo (JP)

(72) Inventor: Yuichi OGAWA, Izunokuni Shizuoka (JP)

(21) Appl. No.: 16/924,046

(22) Filed: Jul. 8, 2020

(30) Foreign Application Priority Data
Sep. 19, 2019 (JP) 2019-170550

(51) Int. Cl. G07G 1/00; G06Q 20/20; G06Q 20/18

(52) U.S. Cl. CPC G07G 1/0009; G06Q 20/18; G06Q 20/204

(57) ABSTRACT

In accordance with an embodiment, a payment apparatus includes a memory, an operation device, and a controller. The controller performs, in a case where the controller determines that payment by a designated payment means is acceptable with respect to at least one commodity of one or more commodities identified on the basis of identification information, payment processing on the at least one commodity identified on the basis of the identification information, for which payment is acceptable, by using the payment means determined to be acceptable for payment. The controller makes, in a case where the controller determines that payment by the designated payment means is inacceptable with respect to all the one or more commodities identified on the basis of the identification information, a notification of guidance indicating that payment by the payment means is inacceptable.

### CROSS-REFERENCE TO RELATED APPLICATION

This application is based upon and claims the benefit of priority from the prior Japanese Patent Application No. 2019-170550, filed on Sep. 19, 2019, the entire contents of which are incorporated herein by reference.

### FIELD

An embodiment described here generally relates to a payment apparatus and a payment method for a payment apparatus.

### BACKGROUND

From the past, a self point of sales (POS) terminal with which a customer performs a sales registration operation and a payment operation at a store, a payment apparatus of a semi-self POS terminal with which a store employee performs the sales registration operation and the customer performs the payment operation, and a normal POS terminal with which the store employee performs the sales registration operation and the payment operation exist.

With those POS terminals, in a case where the payment operation is performed by a credit card for example, some types of credit cards cannot be used for payment for some commodities. Therefore, in a case where commodities to be purchased includes one or more commodities for which payment is inacceptable by such a credit card, that credit card cannot be used for payment for all the commodities.

Such a situation is not limited to credit cards. For example, in a case where commodities to be purchased includes one or more commodities for which payment is acceptable only by cash, it is necessary to perform payment for all the commodities by cash.

### BRIEF DESCRIPTION OF THE DRAWINGS

FIG. 1 is a schematic diagram showing a POS system according to an embodiment.

FIG. 2 is a front view showing an outer appearance of a self POS terminal according to the embodiment.

FIG. 3 is a block diagram showing a hardware configuration of the self POS terminal according to the embodiment.

FIG. 4 is a memory map showing a commodity table according to the embodiment.

FIG. 5 is a functional block diagram showing a functional configuration of the self POS terminal according to the embodiment.

FIG. 6 is a flowchart showing control processing of the self POS terminal according to the embodiment.

FIG. 7 is a diagram showing a display screen of a display device according to the embodiment.

FIG. 8 is a diagram showing another display screen of the display device according to the embodiment.

FIG. 9 is a diagram showing still another display screen of the display device according to the embodiment.

FIG. 10 is a diagram showing still another display screen of the display device according to the embodiment.

FIG. 11 is a diagram showing a display screen of a display device according to a modified example of the embodiment.

### DETAILED DESCRIPTION

In accordance with one embodiment, a payment apparatus performs payment processing for one or more commodities subjected to sales registration processing by using a designated payment means of a plurality of payment means. The payment apparatus includes a memory, an operation device, and a controller. The memory stores identification information for identifying the one or more commodities subjected to the sales registration processing. The operation device receives designation of the payment means. The controller determines whether or not payment by the designated payment means is acceptable with respect to the one or more commodities identified on the basis of the identification information stored in the memory. The controller performs, in a case where the controller determines that payment by the designated payment means is acceptable with respect to at least one commodity of the one or more commodities identified on the basis of the identification information, the payment processing on the at least one commodity identified on the basis of the identification information, for which payment is acceptable, by using the payment means determined to be acceptable for payment. The controller makes, in a case where the controller determines that payment by the designated payment means is inacceptable with respect to all the one or more commodities identified on the basis of the identification information, a notification of guidance indicating that payment by the payment means is inacceptable.

Hereinafter, an embodiment will be described in detail with reference to the drawings. The same reference signs in the drawings will denote the same or similar portions. In the embodiment, descriptions will be given assuming that a self POS terminal is an example of the payment apparatus. The following descriptions should not be construed as limiting embodiments.

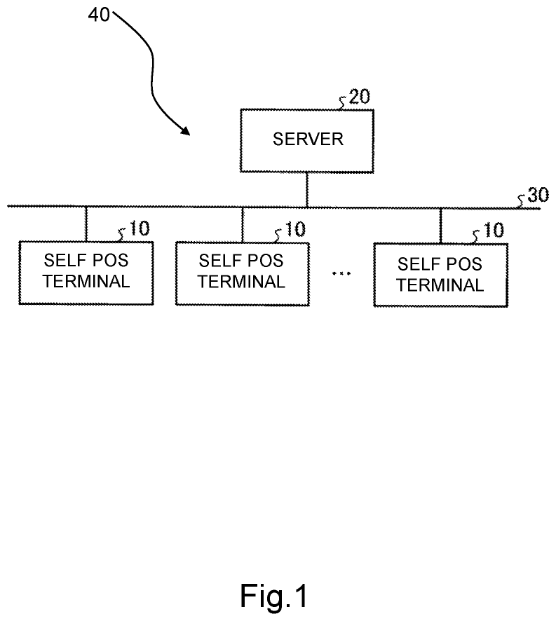

FIG. 1 shows a POS system according to the embodiment. A POS system 40 shown in FIG. 1 is a system that sells commodities to be sold at a store and performs sales management or the like on the sold commodities. The POS system 40 is primarily placed in the store. The POS system 40 includes a plurality of self POS terminals 10 and a single server 20. The self POS terminal 10 is placed in the store. The server 20 is placed in the backyard of the store. The server 20 is a superordinate apparatus for the self POS terminal 10. The self POS terminal 10 and the server 20 are electrically connected with a communication line 30 such as a local area network (LAN). Therefore, each self POS terminal and the server 20 are capable of sending and receiving information to/from each other.

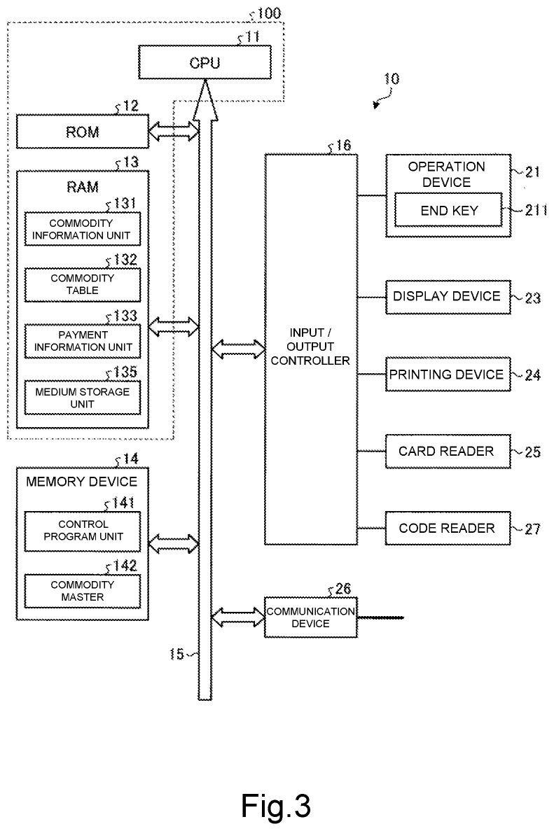

The self POS terminal 10 receives a sales registration operation and a payment operation for one or more commodities purchased by the customer, the sales registration operation and the payment operation being made by the customer. When the customer performs the sales registration operation of reading an image of a symbol such as a barcode added to each commodity to be purchased, the self POS terminal 10 performs sales registration processing for the commodity. The sales registration processing includes processing in which the self POS terminal 10 obtains a commodity code from a symbol. The sales registration processing includes processing in which commodity information (commodity name, price, etc.) of the commodity is read from a commodity master 142 (see FIG. 3) on the basis of the obtained commodity code and displays the read commodity information (commodity name, price, etc.). In addition, the sales registration processing includes processing of storing the read commodity information in commodity information unit 131 (see FIG. 3). It should be noted that the self POS terminal 10 may obtain the commodity code corresponding to the commodity by optically reading the image of the symbol added to the commodity.

In addition, when the customer performs the payment operation, the self POS terminal 10 performs payment processing. The payment processing includes processing of displaying the total amount associated with this transaction on the basis of the commodity information stored in the commodity information unit 131 in the sales registration processing. In addition, the payment processing includes processing of calculating the change on the basis of received money from the customer and displaying the calculated change. In addition, in a case of payment by cash, the payment processing includes processing of instructing a change machine to eject the change. In addition, in a case of payment by credit card, the payment processing includes electronic payment processing using the credit card. In addition, the payment processing includes processing of issuing a receipt on which information regarding a commodity subjected to the sales registration processing and payment information (total amount, received amount, change amount, and the like) have been printed.

The self POS terminal 10 sends the commodity code, the commodity information, the payment information, and the like regarding the commodity subjected to the payment processing to the server 20 via the communication line 30. In addition, the self POS terminal 10 sends adjustment information indicating that sales for a predetermined period (e.g., one day) have been adjusted to the server 20 via the communication line 30.

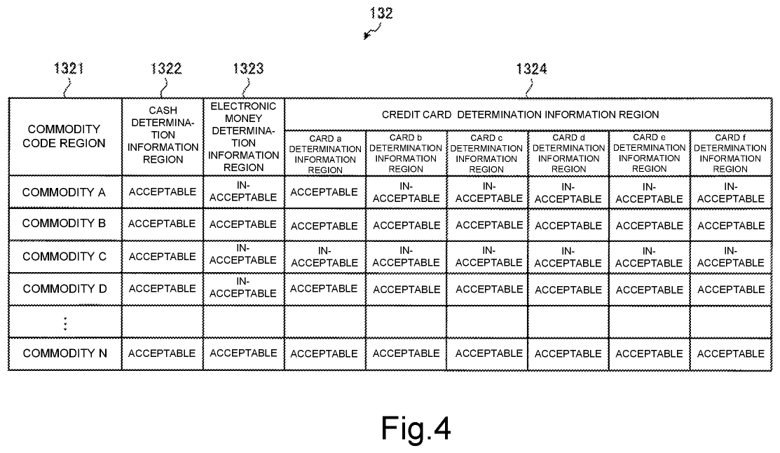

The server 20 comprehensively manages the commodity code, the commodity information, the payment information, the adjustment information, and the like received from each self POS terminal 10. That is, the server 20 performs sales management and the like at a single store. In addition, the server 20 sends the information stored in the commodity master 142 to each self POS terminal 10. The commodity master 142 stores the commodity information regarding the commodity in association with the commodity code for identifying the commodity. In addition, the server 20 stores the commodity table. The commodity table is regularly delivered to the self POS terminal 10 from the server 20 as will be described later with reference to FIGS. 3 and 4.

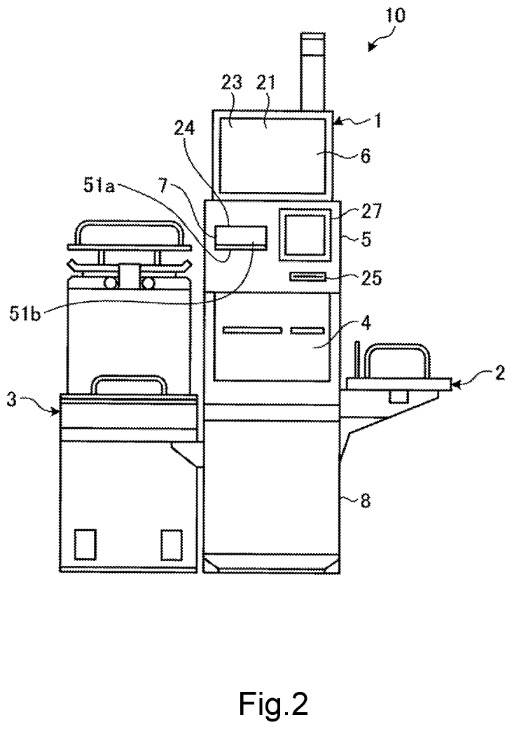

FIG. 2 shows an outer appearance of the self POS terminal 10 according to the embodiment. As shown in FIG. 2, the self POS terminal 10 includes a payment terminal 1, a shopping basket table 2, and a bagging table 3. The payment terminal 1 includes a money dispensing device 4, a reading device 5, a display operation device 6, and a controller 100 (see FIG. 3) that controls each device.

The payment terminal 1 includes a first casing 7 and a second casing 8. The first casing 7 houses the money dispensing device 4. The second casing 8 houses the controller 100 to be described later.

The reading device 5 includes a code reader 27 that reads the outer appearance of the commodity and the symbol (barcode, two-dimensional code, or the like) added to the commodity in order to identify the commodity. In addition, the reading device 5 includes a printing device 24 that outputs a receipt on which the commodity information and the payment information have been printed. The printing device 24 issues the output receipt through a receipt issuing port 51b. The issued receipt is supported by a receipt discharging plate 51a from below. In addition, the reading device 5 includes a card reader 25 that reads a credit card and an electronic money card associated with the payment processing.

The display operation device 6 includes a display device 23 and an operation device 21 including a touch panel, for example. The display device 23 is a monitor, for example. The display device 23 displays information and images. The operation device 21 includes a touch panel provided on a surface of the display device 23, for example. Information based on a position touched by an operator of the touch panel of the operation device 21 is output to the controller 100.

The shopping basket table 2 is a table on which a shopping basket including commodities is placed. The shopping basket table 2 is provided on a lateral side of the payment terminal 1. The customer makes an operation of taking a commodity out of the shopping basket and causing the commodity to face the reading device 5. The bagging table 3 is a table for the customer to put a commodity whose symbol has been scanned by the code reader 27 into a bag. The bagging table 3 is provided on the other lateral side of the payment terminal 1 (on the side opposite to the shopping basket table 2).

Subsequently, a hardware configuration of the self POS terminal 10 will be described. FIG. 3 shows the hardware configuration of the self POS terminal 10. As shown in FIG. 3, the self POS terminal 10 includes the above-mentioned controller 100. The controller 100 includes a central processing unit (CPU) 11, a read only memory (ROM) 12, and a random access memory (RAM) 13. In addition, the self POS terminal 10 includes a memory device 14 and the like. The CPU 11 performs control. The ROM 12 stores various programs. The RAM 13 expands programs and various types of data. The memory device 14 stores various programs. The CPU 11, the ROM 12, the RAM 13, and the memory device 14 are connected to each other via a bus 15. The controller 100 performs control processing associated with the self POS terminal 10 to be described later in such a manner that the CPU 11 is stored in the ROM 12 and the memory device 14 and operates in accordance with a control program expanded in the RAM 13.

The RAM 13 includes the commodity information unit 131 (storage unit), a commodity table 132 (table), a payment information unit 133, and a medium storage unit 135. The commodity information unit 131 stores the commodity code of the commodity subjected to the sales registration processing on the basis of the commodity code obtained from the symbol scanned through the code reader 27 and the commodity information (commodity name, commodity's price, etc.). In the commodity table 132, determination information for determining whether or not payment by the medium (payment means) is acceptable with respect to each commodity code (identification information) has been stored. In the embodiment, the determination information for determining whether or not payment by the medium is acceptable with respect to the commodity having the commodity code with respect to each combination of the commodity code that is the determination information with a plurality of media used for payment has been stored in the commodity table 132. Details of the commodity table 132 will be described later (FIG. 4). The payment information unit 133 stores the determination information obtained from the commodity table 132 with respect to each commodity code stored in the commodity information unit 131. The medium storage unit 135 stores a medium designated through the operation device 21.

The memory device 14 includes a nonvolatile memory such as a hard disc drive (HDD) and a flash memory in which stored information is retained even after it is powered off. The memory device 14 includes a control program unit 141 and the commodity master 142. The control program unit 141 stores the control program for controlling the self POS terminal 10. The commodity master 142 stores the commodity information associated with the commodity for each commodity.

In addition, as shown in FIG. 3, the controller 100 connects to the operation device 21, the display device 23, the printing device 24, the card reader 25, the code reader 27, and the money dispensing device 4 via the bus 15 and a input/output controller 16. The operation device 21 includes an end key 211. The end key 211 receives a customer's operation for terminating the sales registration operation associated with the commodity and starting the payment operation. The money dispensing device 4 deposits money received from the customer and withdraws the change given to the customer.

In addition, as shown in FIG. 3, the controller 100 connects to a communication device 26 via the bus 15. The communication device 26 electrically connects to another self POS terminal 10 placed in the store and the server 20 via the communication line 30. The communication device 26 sends/receives information to/from the other self POS terminal 10 and the server 20.

Next, the commodity table 132 will be described. FIG. 4 is a memory map showing the commodity table. As shown in FIG. 4, in the commodity table 132, the determination information for determining whether or not payment by the medium is acceptable with respect to the commodity having the commodity code with respect to each combination of the commodity code with the plurality of media (payment means) that are the plurality of payment means for paying for the commodity has been stored. In FIG. 4, the plurality of media is cash, electronic money, and six types of credit cards that are cards a to f. The determination information is information indicating whether it is a medium usable or unusable for payment for each commodity. Specifically, “acceptable” information indicating that it is usable for payment or “inacceptable” information indicating that it is unusable for payment is stored as the determination information with respect to each combination of the commodity code with the plurality of media used for payment. That is, the “acceptable” information and the “inacceptable” information are the determination information.

As shown in FIG. 4, the commodity table 132 includes a commodity code region 1321, a cash determination information region 1322, an electronic money determination information region 1323, and a credit card determination information region 1324. In the commodity code region 1321, a commodity code for identifying each commodity is stored. In the cash determination information region 1322, the “acceptable” information or the “inacceptable” information indicating whether or not payment by cash is acceptable with respect to each commodity having the commodity code stored in the commodity code region 1321 is stored. In the electronic money determination information region 1323, the “acceptable” information or the “inacceptable” information indicating whether or not payment by electronic money is acceptable with respect to each commodity having the commodity code stored in the commodity code region 1321 is stored. In the credit card determination information region 1324, the “acceptable” information or the “inacceptable” information indicating whether or not payment by each of the six types of credit cards (cards a to f) is acceptable with respect to each commodity having the commodity code stored in the commodity code region 1321 is stored.

That is, it can be seen from the commodity table 132 shown in FIG. 4 that for a commodity A, payment by the cash and the card a is acceptable and payment by electronic money and the cards b to f is inacceptable. In addition, it can be seen from the commodity table 132 that for a commodity B and a commodity N, payment by any one of the cash, the electronic money, and the cards a to f is acceptable and no media by which payment is inacceptable exist. In addition, it can be seen from the commodity table 132 that for a commodity C, payment only by cash is acceptable and payment by the other media is inacceptable. In addition, it can be seen from the commodity table 132 that for a commodity D, payment by electronic money is inacceptable and payment by the other media is acceptable.

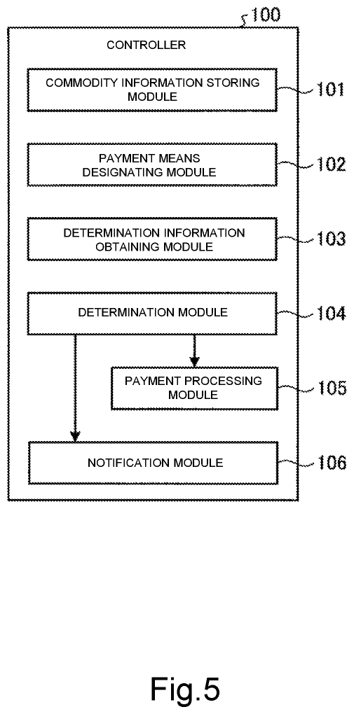

Next, a functional configuration of the self POS terminal 10 will be described in detail. FIG. 5 shows the functional configuration of the self POS terminal 10. In accordance with the control program stored in the control program unit 141 of the memory device 14, the controller 100 functions as a commodity information storing module 101, a payment means designating module 102, a determination information obtaining module 103, a determination module 104, a payment processing module 105, and an notification module 106.

With respect to one or more commodities subjected to the sales registration processing, the commodity information storing module 101 stores the commodity code for identifying the commodity in the commodity information unit 131 of the RAM 13.

The payment means designating module 102 receives information regarding a medium that is designated one of the payment means. Specifically, the payment means designating module 102 stores, in the medium storage unit 135 of the RAM 13, information regarding a medium associated with an operated medium key of keys (hereinafter, simply referred to as medium key) corresponding to various media displayed on the display device 23.

The determination information obtaining module 103 searches on the basis of the commodity table 132 the commodity code stored in the commodity information unit 131 of the RAM 13 by the commodity information storing module 101. The determination information obtaining module 103 obtains the determination information associated with the commodity code as a result of search and stores the obtained determination information in the payment information unit 133 of the RAM 13.

The determination module 104 determines whether or not payment by the medium whose information has been stored in the medium storage unit 135 is acceptable with respect to the commodity having the commodity code stored in the commodity information unit 131 on the basis of the determination information obtained from the commodity table 132 (i.e., the determination information stored in the payment information unit 133).

In a case where it is determined that payment by the medium designated by the operation device 21 is acceptable with respect to at least one of the commodities identified on the basis of the commodity codes (identification information) stored in the commodity information unit 131, the payment processing module 105 performs the payment processing on the commodities for which payment is acceptable by using the designated medium. The determination as to whether or not payment by the designated medium is acceptable is made on the basis of the determination information stored in the predetermined table. The determination information for determining whether or not payment by the medium is acceptable is stored in the predetermined table for each piece of identification information (for each commodity code). The predetermined table refers to the commodity table 132 according to the embodiment. As described above, the determination information for determining whether or not payment by the medium is acceptable with respect to the commodity having the commodity code (“acceptable” or “inacceptable” information) is stored in the commodity table 132 for each combination of the commodity code with the plurality of media. Specifically, in a case where the determination module 104 determines that payment is acceptable, the payment processing module 105 performs the payment processing on the commodity for which payment is acceptable.

In a case where the determination module 104 determines that payment by the designated medium is inacceptable with respect to all the commodities associated with the identification information (commodity codes) on the basis of the commodity table 132, the notification module 106 makes a notification of guidance indicating that payment by the designated medium is inacceptable. Specifically, in case where the determination module 104 determines that payment is inacceptable with respect to all the commodities, the notification module 106 makes a notification of guidance indicating that payment by the designated medium is inacceptable. It should be noted that all the commodities can be a single commodity in some cases.

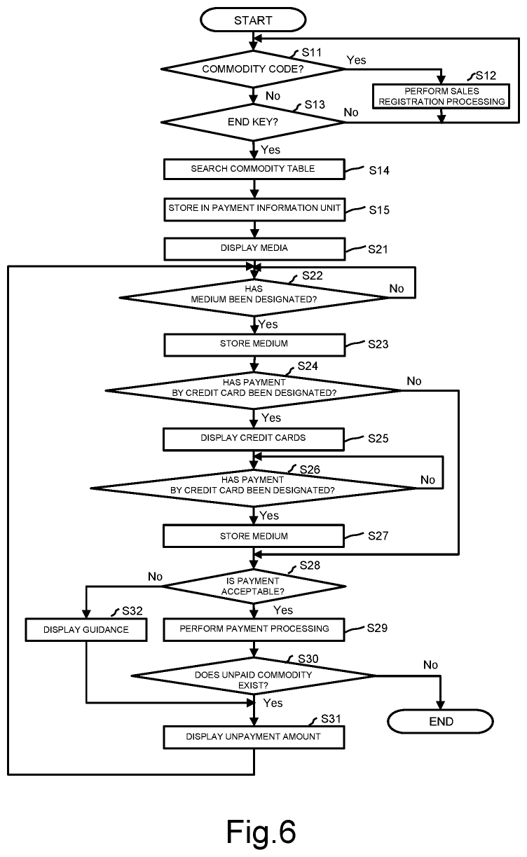

Next, the control of the self POS terminal 10 will be described. FIG. 6 shows a flow of control processing of the self POS terminal 10. As shown in FIG. 6, in Step S11, the controller 100 of the self POS terminal 10 determines whether the code reader 27 has obtained a commodity code associated with this commodity on the basis of a read symbol. In a case where the controller 100 determines that the code reader 27 has obtained the commodity code (Yes in Step S11), the processing of the controller 100 proceeds to Step S12. In Step S12, the controller 100 performs the sales registration processing on the commodity. In addition, in Step S12, the commodity information storing module 101 of the controller 100 stores the commodity code for identifying the commodity in the commodity information unit 131 of the RAM 13 with respect to one or more commodities subjected to the sales registration processing. In the embodiment, for example, it is assumed that the commodity codes of three commodities of the commodity A, the commodity B, and the commodity D have been stored in the commodity information unit 131. Then, the processing of the controller 100 returns to Step S11.

In addition, in a case where the controller 100 determines that the code reader 27 has not obtained the commodity code (No in Step S11), the processing of the controller 100 proceeds to Step S13. In Step S13, the controller 100 determines whether or not the end key 211 has been operated. In a case where the controller 100 determines that the end key 211 has been operated (Yes in Step S13), the processing of the controller 100 proceeds to Step S14. In Step S14, the controller 100 searches the commodity table 132 on the basis of all the commodity codes (commodity codes of the commodity A, the commodity B, and the commodity D) stored in the commodity information unit 131 of the RAM 13. Then, in Step S15, the determination information obtaining module 103 of the controller 100 obtains, for each commodity code, the determination information associated with the commodity code from the commodity table 132 and stores the obtained determination information in the payment information unit 133 of the RAM 13. That is, in the embodiment, the determination information associated with the commodity A, the commodity B, and the commodity D is stored. It should be noted that in a case where the controller 100 determines that the end key 211 has not been operated (No in Step S13), the processing of the controller 100 returns to Step S11.

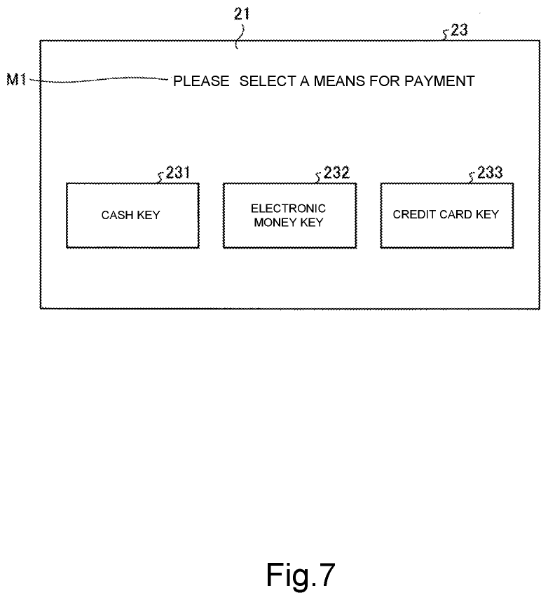

Next, in Step S21, the controller 100 displays media usable at that store on the display device 23. FIG. 7 shows a screen when the usable media are displayed on the display device 23 in Step S21. As shown in FIG. 7, the display device 23 displays a cash key 231, an electronic money key 232, and a credit card key 233 as keys for designating a medium. For payment by cash, the customer operates the cash key 231. For payment by electronic money, the customer operates the electronic money key 232. For payment by credit card, the customer operates the credit card key 233. In addition, as shown in FIG. 7, the display device 23 displays guidance M1 for prompting the customer to operate any one of the cash key 231, the electronic money key 232, and the credit card key 233. The guidance M1 is, for example, “Please select a means for payment”.

The description of FIG. 6 will be continued. In Step S22, the controller 100 determines whether or not any one medium key of the cash key 231, the electronic money key 232, and the credit card key 233 shown in FIG. 7 has been operated (any one medium has been designated). The controller 100 stands by until any one medium key has been operated (No in Step S22). In a case where the controller 100 determines that any one medium key has been operated (Yes in Step S22), the processing of the controller 100 proceeds to Step S23. In Step S23, the payment means designating module 102 of the controller 100 stores information indicating the medium associated with the operated medium key in the medium storage unit 135 of the RAM 13. That is, the payment means designating module 102 receives information regarding a single designated medium.

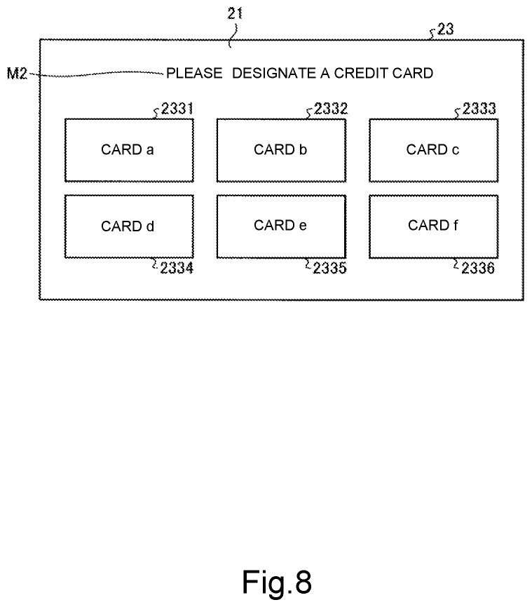

Next, in Step S24, the controller 100 determines whether or not the credit card has been designated as the payment means (i.e., whether or not the information stored in the medium storage unit is the information regarding the credit card key 233). In other words, the controller 100 determines whether or not the information stored in the medium storage unit 135 is the information regarding the credit card key 233. In a case where the controller 100 determines that the credit card has been designated (Yes in Step S24), the processing of the controller 100 proceeds to Step S25. In Step S25, the controller 100 causes the display device 23 to display the types of credit cards usable at the store. FIG. 8 shows a screen related to the credit cards displayed on the display device 23 in Step S25. As shown in FIG. 8, the display device 23 displays medium keys for designating the six types of cards, i.e., a key 2331 for designating the card a, a key 2332 for designating the card b, a key 2333 for designating the card c, a key 2334 for designating the card d, a key 2335 for designating the card e, and a key 2336 for designating the card f. The customer operates any one of the medium keys 2331 to 2336 for designating any one of the credit cards a to f to be used. In the embodiment, it is assumed that the customer has designated the card b. In addition, the display device 23 displays guidance M2 for prompting the customer to designate the credit card to be used. The guidance M2 is, for example, “Please designate a credit card”.

The description of FIG. 6 will be further continued. The controller 100 determines whether or not any one of the credit cards a to f has been designated. In other words, the controller 100 determines whether or not any one of the medium keys 2331 to 2336 has been operated. The controller 100 stands by until any one of the credit cards a to f is designated (No in Step S26). In a case where the controller 100 determines that any one of the credit cards a to f has been designated (Yes in Step S26), the processing of the controller 100 proceeds to Step S27. In Step S27, the payment means designating module 102 of the controller 100 receives information regarding a single designated credit card. Specifically, the payment means designating module 102 of the controller 100 stores, in the medium storage unit 135 of the RAM 13, the information regarding the credit card associated with the operated key of the medium keys 2331 to 2336 for designating the various cards displayed on the display device 23. That is, in the embodiment, the information regarding the card b is stored in the medium storage unit 135.

Next, in Step S28, the determination module 104 of the controller 100 determines whether or not payment by the medium (credit card) stored in the medium storage unit 135 is acceptable with respect to the commodity having the commodity code stored in the commodity information unit 131 on the basis of the determination information stored in the payment information unit 133 of the RAM 13. In the embodiment, the determination module 104 determines whether or not payment by the card b is acceptable with respect to the commodity A, the commodity B, or the commodity D. In a case where the determination module 104 determines that payment by the card b is acceptable (Yes in Step S28), the processing of the controller 100 proceeds to Step S29. In Step S29, the payment processing module 105 of the controller 100 performs the payment processing on a commodity for which payment is acceptable out of the commodities having the commodity codes stored in the commodity information unit 131 of the RAM 13. In the embodiment, since payment by the card b is acceptable with respect to the commodity B and the commodity D, the payment processing module 105 performs the payment processing on the commodity B and the commodity D in Step S29. In addition, the controller 100 removes the commodity codes and the commodity information of the commodity B and the commodity D subjected to the payment processing from the commodity information unit 131 of the RAM 13. Then, the commodity A is a commodity for which payment has not been done, that is, an unpaid commodity. Therefore, the commodity code and the commodity information associated with the commodity A is still stored in the commodity information unit 131. It should be noted that in Step S24, in a case where the controller 100 determines that the credit card has not been designated (No in Step S24), the determination module 104 of the controller 100 performs the above-mentioned determination processing of Step S28 instead of performing the processing of Steps S25 to S27.

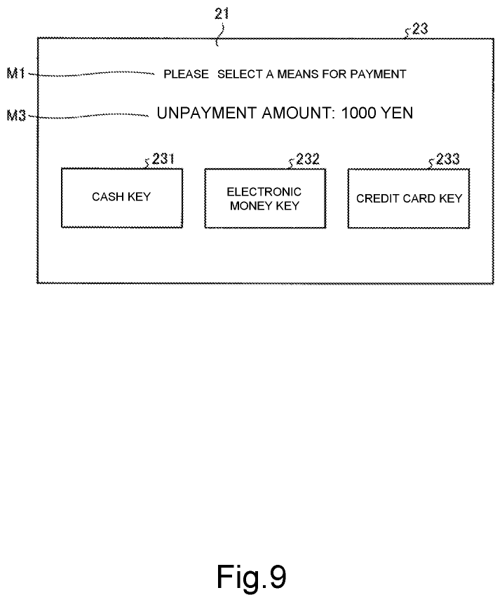

Next, in Step S30, the controller 100 determines whether or not the unpaid commodity exists. The controller 100 determines that the unpaid commodity exists in a case where the commodity code and the commodity information have been stored in the commodity information unit 131 of the RAM 13. In a case where the controller 100 determines that the unpaid commodity exists (Yes in Step S30), the processing of the controller 100 proceeds to Step S31. In Step S31, the controller 100 calculates the total amount of the unpaid commodity on the basis of the commodity information stored in the commodity information unit 131 of the RAM 13 and causes the display device 23 to display the calculated total amount. FIG. 9 shows a screen of the display device 23 on which the guidance and the total amount of the unpaid commodity is displayed. The display device 23 displays the guidance M1, guidance M3, the cash key 231, the electronic money key 232, and the credit card key 233. The guidance M3 indicates that the unpaid commodity exists and the total amount of the unpaid commodity. The customer recognizes that the unpaid commodity exists on the basis of the displayed guidance M3. Then, the customer operates any one medium key of the cash key 231, the electronic money key 232, and the credit card key 233 for the unpaid commodity and designates a medium to be used for payment. In addition, the controller 100 returns to the processing of Step S22 and waits for designation of a new medium. In the embodiment, since the commodity A is still unpaid, the controller 100 waits for designation of a medium to be newly used for the commodity A. Since payment by cash or the card a is acceptable with respect to the commodity A, the payment processing module 105 of the controller 100 performs the payment processing on the commodity A when the customer designates cash or the card a. On the other hand, in a case where the controller 100 determines that the unpaid commodity does not exist (No in Step S30), payment for all the commodities is completed, and thus the controller 100 terminates the processing shown in FIG. 6.

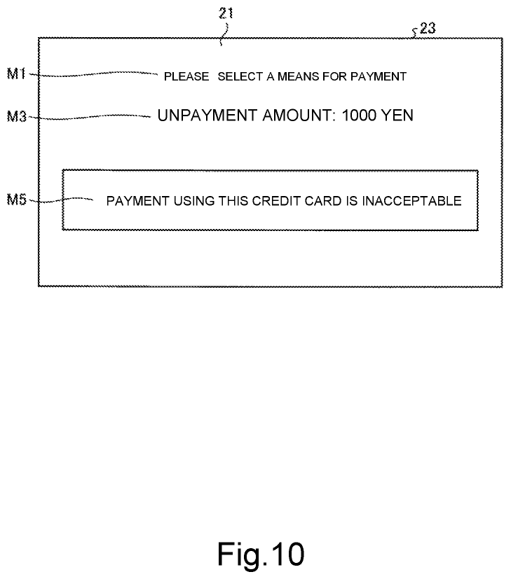

In addition, in Step S28, in a case where the controller 100 determines that payment by the medium stored in the medium storage unit 135 of the RAM 13 is inacceptable with respect to all the commodities having the commodity codes stored in the commodity information unit 131 of the RAM 13 (No in Step S28), the processing of the controller 100 proceeds to Step S32. In Step S32, the notification module 106 of the controller 100 displays (makes a notification of) guidance indicating that payment by the designated medium is inacceptable. FIG. 10 shows a screen of the display device on which the guidance indicating that payment by the designated medium is inacceptable. The display device 23 displays the guidance M1, the guidance M3, and guidance M5 indicating that payment by the designated medium is inacceptable. In a case where the customer purchases the commodity A and the commodity C and designates the card b for example, the guidance M5 is displayed on the display device 23. The guidance M5 is, for example, “Payment using this credit card is inacceptable”. Then, the controller 100 performs the processing of Step S31.

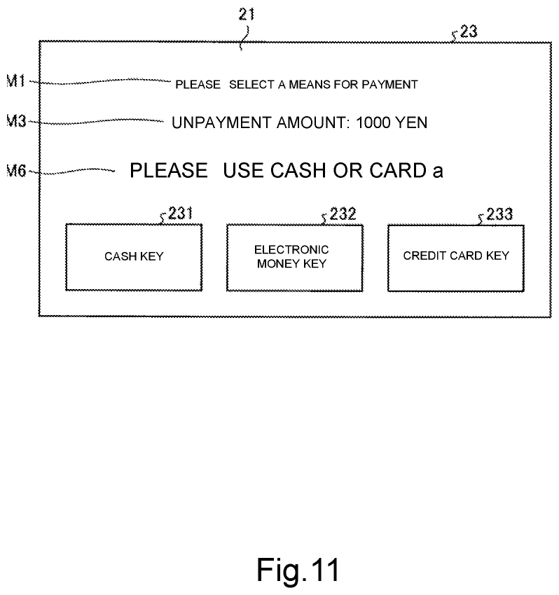

It should be noted that as a modified example of the display in Step S31, a medium usable for payment for the unpaid commodity may be displayed in addition to the guidance M3. FIG. 11 shows a display screen of a modified example in which guidance M6 showing information indicating that payment is acceptable with respect to the unpaid commodity, for example, information indicating a medium usable for payment for the unpaid commodity is added to the display screen of FIG. 9. For example, in a case where the commodity A is the unpaid commodity, the guidance M6 is, for example, “Please use cash or card a”.

As described above, the controller 100 of the self POS terminal 10 according to the embodiment includes the module 101, the payment means designating module 102, the payment processing module 105, and the notification module 106. Then, with respect to one or more commodities subjected to the sales registration processing, the commodity information storing module 101 of the controller 100 stores the commodity code (identification information) for identifying the commodity in the commodity information unit 131 of the RAM 13 (storage unit). In addition, the payment means designating module 102 of the controller 100 receives designation of one medium. In addition, in a case where the determination module 104 of the controller 100 determines that payment by the medium (payment means) whose designation has been received is acceptable with respect to at least one of the commodities associated with the commodity codes on the basis of the determination information stored in the commodity table 132, the payment processing module 105 of the controller 100 performs the payment processing on the commodities for which payment is acceptable by using the medium. As described above, the determination information has been stored in the commodity table 132 for each combination of the commodity code with the plurality of media. The determination information is information for determining whether or not payment by the medium is acceptable with respect to the commodity identified on the basis of the commodity code. In addition, the notification module 106 of the controller 100 makes a notification of guidance indicating that payment by the medium is inacceptable in a case where the determination module 104 of the controller 100 determines that payment by the designated medium is inacceptable with respect to all the commodities associated with the commodity codes on the basis of the commodity table 132. Such a self POS terminal 10 performs the payment processing on the commodity in a case where payment by the designated medium is acceptable with respect to the one or more commodities subjected to the sales registration processing. In addition, in a case where payment by the designated medium is inacceptable with respect to all the commodities, the self POS terminal 10 displays guidance indicating that payment by the medium is inacceptable with respect to notification. With this configuration, the range of usable media can be widened.

It should be noted that for example, in the embodiment, the description has been made by using the self POS terminal 10 as an example of the payment terminal, though not limited thereto. The payment terminal may be a payment terminal in a normal POS terminal or a semi-self POS terminal.

In addition, in the above-mentioned embodiment, it has been assumed that the self POS terminal 10 includes the commodity table 132, though not limited thereto. The server 20 may include the commodity table 132, for example.

In addition, in the embodiment, the determination information for determining whether or not payment by the medium is acceptable with respect to the commodity having the commodity code is stored in the commodity table 132 for each combination of the commodity code with the plurality of media (payment means), though not limited thereto. A usable medium may be stored in the commodity table 132 for each commodity code in association with each other, for example. In this case, the determination module 104 of the controller 100 determines that payment is acceptable in a case where the designated medium is set as a usable medium with respect to the commodity code and determines that payment cannot be performed in a case where the designated medium is not set as the usable medium. In addition, an unusable medium may be stored for each commodity (commodity code) in association with each other. In this case, the determination module 104 of the controller 100 determines that payment is inacceptable in a case where the designated medium is set as the unusable medium and determines that payment is acceptable in a case where the designated medium is not set as the unusable medium.

It should be noted that a program executed by the self POS terminal 10 according to the embodiment is provided, recorded on a computer-readable recording medium such as a CD-ROM, a flexible disk (FD), a CD-R, and a digital versatile disk (DVD) in a file in an installable format or an executable format.

In addition, the program executed by the self POS terminal 10 according to the embodiment may be stored in the computer connected to a network such as the Internet and may be provided by being downloaded via the network. In addition, the program executed by the self POS terminal 10 according to the embodiment may be provided or distributed via the network such as the Internet.

In addition, the program executed by the self POS terminal 10 according to the embodiment may be provided by being incorporated in the ROM or the like in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A payment apparatus that performs payment processing for one or more commodities subjected to sales registration processing by using a designated payment means of a plurality of payment means, comprising:
a memory that stores identification information for identifying the one or more commodities subjected to the sales registration processing;
an operation device that receives designation of the payment means; and
a controller that
determines whether or not payment by the designated payment means is acceptable with respect to the one or more commodities identified on a basis of the identification information stored in the memory,
performs, in a case where the controller determines that payment by the designated payment means is acceptable with respect to at least one commodity of the one or more commodities identified on a basis of the identification information, the payment processing on the at least one commodity identified on a basis of the identification information, for which payment is acceptable, by using the payment means determined to be acceptable for payment, and
makes, in a case where the controller determines that payment by the designated payment means is inacceptable with respect to all the one or more commodities identified on a basis of the identification information, a notification of guidance indicating that payment by the payment means is inacceptable.

2. The payment apparatus according to claim 1, wherein
the memory includes
a commodity information unit that stores identification information for identifying the commodity with respect to the one or more commodities subjected to the sales registration processing and
a commodity table for storing determination information for determining which one of the plurality of payment means is acceptable for payment, the determination information being stored in association with the identification information, and
the controller determines, on a basis of the determination information stored in the commodity table, whether or not payment by the designated payment means is acceptable with respect to the one or more commodities identified on a basis of the identification information stored in the commodity information unit.

3. The payment apparatus according to claim 2, wherein
the controller obtains the determination information from the commodity table with respect to each piece of identification information stored in the commodity information unit, and
the memory further includes a payment information unit that stores the determination information obtained from the commodity table with respect to each piece of identification information stored in the commodity information unit.

4. The payment apparatus according to claim 3, wherein
the controller
obtains the determination information associated with the identification information by searching the commodity table on a basis of the identification information stored in the commodity information unit, and
stores the obtained determination information in the payment information unit.

5. The payment apparatus according to claim 3, wherein
the controller obtains information regarding the designated payment means, and
the memory further includes a medium storage unit that stores the information regarding the designated payment means.

6. The payment apparatus according to claim 5, wherein
the controller determines whether or not payment by the payment means indicated by the information stored in the medium storage unit is acceptable with respect to the one or more commodities identified on a basis of the identification information stored in the commodity information unit.

7. The payment apparatus according to claim 2, wherein
the controller removes, upon the payment processing, the identification information of the commodity subjected to the payment processing from the commodity information unit.

8. The payment apparatus according to claim 7, wherein
the controller makes, after the payment processing, a notification of information associated with unpayment in a case where the identification information is stored in the commodity information unit.

9. The payment apparatus according to claim 8, wherein
the controller makes a notification of unpayment amount information associated with the an unpaid commodity identified on a basis of the identification information stored in the commodity information unit as the information associated with the unpayment.

10. A payment method for a payment apparatus that performs payment processing for one or more commodities subjected to sales registration processing by using a designated payment means of a plurality of payment means, the method comprising:
storing, in a memory, identification information for identifying the one or more commodities subjected to the sales registration processing;
receiving, by an operation device, designation of the payment means;
determining whether or not payment by the designated payment means is acceptable with respect to the one or more commodities identified on a basis of the identification information stored in the memory;
performing, in a case where the controller determines that payment by the designated payment means is acceptable with respect to at least one commodity of the one or more commodities identified on a basis of the identification information, the payment processing on the at least one commodity identified on a basis of the identification information, for which payment is acceptable, by using the payment means determined to be acceptable for payment; and
making, in a case where the controller determines that payment by the designated payment means is inacceptable with respect to all the one or more commodities identified on a basis of the identification information, a notification of guidance indicating that payment by the payment means is inacceptable.
